(19) United States
(12) Patent Application Publication
(10) Pub. No.: US 2026/0082110 A1
(43) Pub. Date: Mar. 19, 2026

(54) DYNAMICALLY GENERATED VIDEO COMPARISON SUMMARY

(71) Applicant: INTERNATIONAL BUSINESS MACHINES CORPORATION, ARMONK, NY (US)

(72) Inventors: Sarbajit Kumar Rakshit, Kolkata (IN); Sathya Santhar, Ramapuram (IN); Sridevi Kannan, Katupakkam, Chennai (IN); Samuel Mathew Jawaharlal, Chennai (IN)

(21) Appl. No.: 18/888,562

(22) Filed: Sep. 18, 2024

(51) Int. Cl. H04N 21/8549; G06F 16/738; G06F 16/75; G06F 16/783

(52) U.S. Cl. CPC H04N 21/8549; G06F 16/739; G06F 16/75; G06F 16/783; G06F 16/7867

(57) ABSTRACT

A method, computer system, and a computer program product for dynamically generated video comparison summary is provided. The present invention may include receiving a query for a video comparing a plurality of topics included in the query. The present invention may then include identifying a plurality of video content relevant to the plurality of topics. The present invention may next include mapping at least one video content of the plurality of video content to respective topics of the plurality of topics. The present invention may further include predicting whether to generate an intra-frame comparison video or an inter-frame comparison video for the video comparing the plurality of topics included in the query. The present invention may then include generating the video comparing the plurality of topics included in the query based on the prediction.

### BACKGROUND

The present invention relates generally to the field of computing, and more particularly to computer vision technologies.

Various video summarization technologies are available to generate a short synopsis of a full-length video by selecting its most informative and important parts. Deep-learning-based techniques may be used to produce a static summary (video storyboard) that is composed of a set of representative video frames or a dynamic summary (video skim) that is composed of a set of video fragments stitched in chronological order to form a shorter video. These video summarization technologies may help a user to navigate large volumes of video data in a video repository to find video content on a specific topic. However, in some instances, a user may want to search for a video comparing multiple topics which may not exist in the video repository.

### SUMMARY

Embodiments of the present invention disclose a method, computer system, and a computer program product for dynamically generated video comparison summary. The present invention may include receiving a query for a video comparing a plurality of topics included in the query. The present invention may then include identifying a plurality of video content relevant to the plurality of topics. The present invention may next include mapping at least one video content of the plurality of video content to respective topics of the plurality of topics. The present invention may further include predicting whether to generate an intra-frame comparison video or an inter-frame comparison video for the video comparing the plurality of topics included in the query. The present invention may then include generating the video comparing the plurality of topics included in the query based on the prediction

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computing environment according to at least one embodiment;

FIG. 2 is a schematic block diagram of video comparison environment according to at least one embodiment;

FIG. 3 is a schematic block diagram of a frame identifier process according to at least one embodiment;

FIG. 4 is a schematic block diagram of a frame classifier process according to at least one embodiment;

FIG. 5 is a schematic block diagram of a summarization process according to at least one embodiment;

FIG. 6 is a schematic block diagram of a comparison prediction process according to at least one embodiment;

FIG. 7 is a schematic block diagram of a video generation process according to at least one embodiment; and

FIG. 8 is an operational flowchart illustrating a video comparison process according to at least one embodiment.

### DETAILED DESCRIPTION

The following described exemplary embodiments provide a system, method and computer program product for dynamically generated video comparison summary. As such, the present embodiment has the capacity to improve the technical field of computer vision by dynamically generating a video that summarizes a comparison between two or more topics requested by a user. More specifically, a video comparison program may receive a query for a video comparing a plurality of topics included in the query. Then, the video comparison program may identify a plurality of video content relevant to the plurality of topics. Next, the video comparison program may map at least one video content of the plurality of video content to respective topics of the plurality of topics. Next, the video comparison program may predict whether to generate an intra-frame comparison video or an inter-frame comparison video for the video comparing the plurality of topics included in the query. Thereafter, the video comparison program may generate the video comparing the plurality of topics included in the query based on the prediction.

As described previously, various video summarization technologies are available to generate a short synopsis of a full-length video by selecting its most informative and important parts. Deep-learning-based techniques may be used to produce a static summary (video storyboard) that is composed of a set of representative video frames or a dynamic summary (video skim) that is composed of a set of video fragments stitched in chronological order to form a shorter video. In video retrieval systems, current video summarization technologies may help a user to navigate large volumes of video data to find video content on a specific topic indicated in the user's query.

If the user's query includes a request for a video comparing multiple specific topics (e.g., user-specified topics), existing technologies may only return the requested video if the requested video was previously made (e.g., manually made) and stored in a video repository. However, if the requested video is not available in the video repository, existing technologies are unable to dynamically (e.g., in real-time) generate a video comparison summary comparing the multiple specific topics. Specifically, existing video summarization techniques are unable to compare specific video frames from a single video or from multiple videos to generate an intra-frame video comparison summary (e.g., video content compared within a same space/frame) or inter-frame video comparison summary (video content compared sequentially between different frames) based on the user's query.

Therefore, it may be advantageous to, among other things, provide a way to receive any comparison query and dynamically generate inter-frame and intra-frame video comparison summaries in real-time. The dynamic generation of video content detailed in the present disclosure may improve the functionality of a computing system such as, a video sharing platform, leading to enhanced user engagement and increased content consumption.

Embodiments of the video comparison program may be implemented using various machine learning techniques. An overview of the various machine learning techniques are provided below.

According to one embodiment, the video comparison program may implement one or more Deep Neural Networks (DNNs). A DNN is a type of Artificial Neural Network (ANN) with multiple hidden layers between the input and output layers. A DNN may be trained to receive a set of inputs, perform progressively complex calculations on the inputs (e.g., modeling complex non-linear relationships), and provide an output to solve real world problems such as, classification. Embodiments of the present disclosure may implement various types of DNNs such as, for example, a Convolutional Neural Network (CNN), a Recurrent Neural Network (RNN), a Long Short-Term Memory Network (LSTM), and a Generative Adversarial Network (GAN).

A CNN may enable a computer to understand and interpret image or visual data to perform computer vision tasks such as, for example, image classification. A CNN may include three types of layers: an input layer, one or more hidden layers, and an output layer. The input layer may be configured to receive an input to the model. The number of neurons in the input layer may be equal to a total number of features in a given set of data (e.g., number of pixels in the case of an image). The output from the input layer may then be feed into the hidden layer. The number of hidden layers may depend on the model and data size. One or more hidden layer may have a different number of neurons (e.g., generally greater than the number of features). The output from one or more hidden layers may be computed by matrix multiplication of the output of the previous layer with learnable weights of that layer and then by the addition of learnable biases followed by an activation function which makes the CNN nonlinear. Then, the output from the hidden layer(s) may be fed into a logistic function (e.g., sigmoid; softmax) which may convert the output of each class into a probability score for each class.

An RNN may enable a computer to process sequential data. An LSTM is a variety of an RNN that is capable of learning long-term dependencies, especially in sequence prediction problems. LSTM has feedback connections, i.e., it is capable of processing the entire sequence of data, apart from single data points such as images. An LSTM model may include a memory cell known as a “cell state” that maintains its state over time. Information can be added to or removed from the cell state in LSTM and is regulated by gates (e.g., input gate, output gate, forget gate). These gates optionally let the information flow in and out of the cell. An LSTM contains a pointwise multiplication operation and a sigmoid neural net layer that assist the mechanism. The sigmoid layer outputs numbers between zero and one, where zero means “nothing should be let through,” and one means “everything should be let through.”

A GAN may enable a computer to train a generative model by framing the problem as a supervised learning problem with two sub-models: a generator model that is trained to generate new examples, and a discriminator model that tries to classify the new examples as either real (from the domain) or fake (generated). The two models are trained together in a zero-sum adversarial game, until the discriminator model is fooled about half the time, meaning the generator model is generating plausible examples. GANs enable tasks such as, image generation and video generation.

According to one embodiment, the video comparison program may implement the various machine learning techniques in the following manner to generate an intra-frame or inter-frame video comparison summary based on the user's input query.

When a search query is entered by a user into a video search engine, if the video comparison program identifies the search query as a comparison query, then the video comparison program may split the search query into multiple independent queries of the topics the user wants to compare and all of the pages/videos which are deemed to be relevant may be identified from a video repository index. A search algorithm may be used to hierarchically rank the relevant pages into a set of results based on the user's query.

Then, the video comparison program may implement a first CNN+LSTM model to analyze the filtered videos from the search results in the previous step to identify the intended shots (e.g., action/object recognition) from the identified videos. Following this process, the video comparison program may output the relevant frames from the identified videos based on the input query.

Next, based on the identified action/objects in the relevant video frames, the video comparison program may employ a first DNN model to classify the relevant video frames based on the key differences and similarities between the relevant video frames in the identified videos. Following this process, the video comparison program may output the relevant video frames classified based on the topics in the user's query that need to be compared.

Next, the video comparison program may employ a CNN classifier to determine whether the classified video frames need to be summarized. If the video comparison program determines that the classified video frames need to be summarized, the classified video frames may be sent to a second CNN+LSTM model which summarizes the video frames for each class. Following this process, the video comparison program may output a summarized version of the video frames of each class of topics from the user's query.

Next, the video comparison program may employ a second DNN model to determine an output format for the video comparison summary. The second DNN model may be trained to predict whether an intra-frame comparison format (e.g., content compared within the same frame) or an inter-frame comparison format (content compared sequentially between different frames) may be best for displaying the video comparison summary based on the user's query and the relevant summarized frames of the classes in the user's query.

Thereafter, the video comparison program may employ a GAN model to generate the video comparison summary based on the classified video frames in the output format predicted by the second DNN model.

In another embodiment, if the user query includes an input video, the video comparison program may extract the text from the input video. Then, the video comparison program may generate a comparison query based on the extracted text from the input video and the user's query. Next, the comparison query may fed into the process described above to generate the video comparison summary with an exception that for part of the query where video input is already available, the video comparison program may not need to re-fetch similar frames to that of the input video.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine-readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

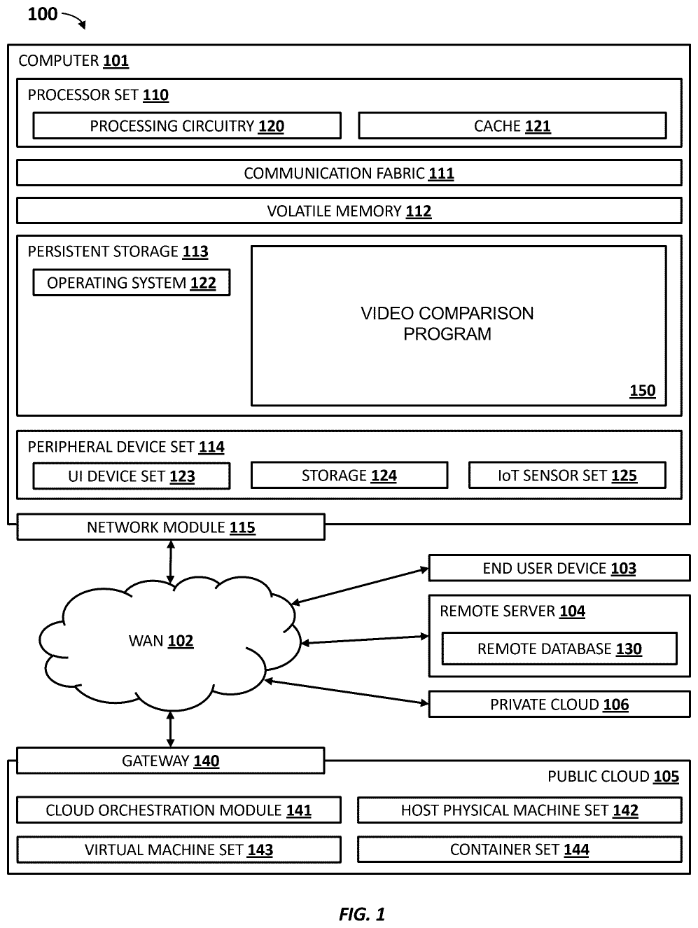

Referring to FIG. 1, a computing environment 100 according to at least one embodiment is depicted. Computing environment 100 contains an example of an environment for the execution of at least some of the computer code involved in performing the inventive methods, such as video comparison program 150. In addition to video comparison program 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and video comparison program 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144. Furthermore, despite only being depicted in computer 101, video comparison program 150 may be stored in and/or executed by, individually or in any combination, EUD 103, remote server 104, public cloud 105, and private cloud 106.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, for illustrative brevity. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 (e.g., video comparison program 150) in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The video comparison program 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth® (Bluetooth and all Bluetooth-based trademarks and logos are trademarks or registered trademarks of Bluetooth SIG, Inc. and/or its affiliates) connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

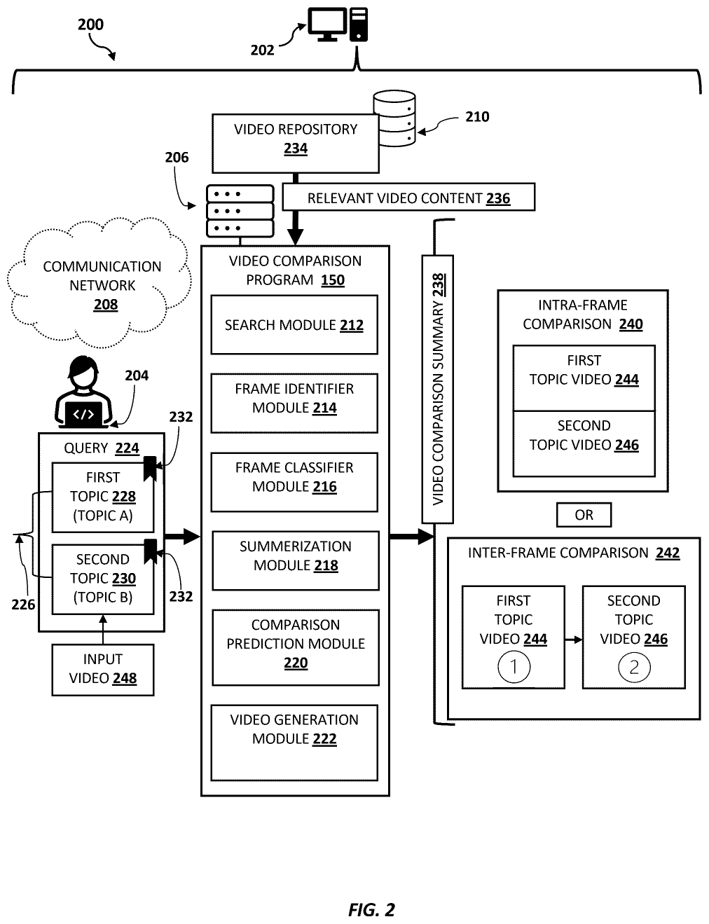

According to the present embodiment, a user using any combination of an EUD 103, remote server 104, public cloud 105, and private cloud 106 may use the video comparison program 150 to dynamically generate a video comparison summary of topics in a user query. Embodiments of the present disclosure are explained in more detail below with respect to FIGS. 2 to 8.

Referring now to FIG. 2, a schematic block diagram of a video comparison environment 200 according to at least one embodiment is depicted. According to one embodiment, the video comparison environment 200 may include a computer system 202 having a tangible storage device and a processor that is enabled to run the video comparison program 150.

Generally, the computer system 202 may be enabled by the video comparison program 150 to receive a query for a video comparison summary comparing a plurality of topics included in the query, identify a plurality of video content relevant to the plurality of topics, map at least one video content of the plurality of video content to respective topics of the plurality of topics, predict whether to generate an intra-frame comparison video or an inter-frame comparison video for the video comparing the plurality of topics included in the query, and generate the video comparison summary comparing the plurality of topics included in the query based on the prediction.

According to one embodiment, the computer system 202 may include one or more components (e.g., computer 101; end user device (EUD) 103; WAN 102) of the computing environment 100 described above with reference to FIG. 1. In one embodiment, the computer system 202 may include one or more client devices 204 (e.g., computer 101) associated with a user and one or more servers 206 (e.g., remote server 104). Client device 204 and server 206 which may take the form of a desktop computer, laptop computer, tablet computer, smart phone, smart watch or other wearable computer, mainframe computer, quantum computer or any other form of computer or mobile device now known or to be developed in the future that is capable of running a program (e.g., video comparison program 150), accessing a communication network 208 (e.g., WAN 102), and/or querying one or more databases 210.

According to one embodiment, client device 204, server 206, and database 210 may be communicatively coupled via the communication network 208. The communication network 208 may include various types of communication networks, such as WAN 102, described with reference to FIG. 1. In some embodiments, the WAN may be replaced and/or supplemented by a local area network (LAN), a telecommunication network (e.g., 3G, 4G, 5G), a wireless network, a public switched network and/or a satellite network. In one embodiment, the communication network 208 may enable data to be transferred between the client device 204, server 206, and database 210 using short-range wireless technologies, such as, for example, Wi-Fi and/or Bluetooth® (Bluetooth and all Bluetooth-based trademarks and logos are trademarks or registered trademarks of Bluetooth SIG, Inc. and/or its affiliates).

In at least one embodiment, aspects of the computer system 202 may operate in a cloud computing service model, such as Software as a Service (SaaS), Platform as a Service (PaaS), or Infrastructure as a Service (IaaS). In one embodiment, the computer system 202 may also be implemented as a cloud computing deployment model, such as a private cloud, community cloud, public cloud, or hybrid cloud.

In one embodiment, the video comparison program 150 may include a single computer program or multiple program modules or sets of instructions being executed by the processor of the computer system 202 (e.g., client device 204, server 206, and database 210). In one embodiment, the video comparison program 150 may include routines, objects, components, units, logic, data structures, and actions that may perform particular tasks or implement particular abstract data types. In one embodiment, the video comparison program 150 may be practiced in distributed cloud computing environments where tasks may be performed by local (e.g., video comparison program 150 running on client device 204) and/or remote processing devices (e.g., video comparison program 150 running on server 206) which may be linked through a communication network 208. In at least one embodiment, the video comparison program 150 (e.g., the various modules) may be executed on a single computing device (e.g., locally on client device 204).

According to one embodiment, the video comparison program 150 may include one or more of the following modules: a search module 212, a frame identifier module 214, a frame classifier module 216, a summarization module 218, a comparison prediction module 220, and a video generation module 222. Embodiments of these modules will be further detailed below with reference to FIGS. 2-7.

According to one embodiment, the video comparison program 150 may be integrated into a video search engine. A user may interact with the client device 204 to input a query 224 into the video search engine associated with the video comparison program 150. In one embodiment, the query 224 may include a prompt or request to return (e.g., output, generate) a video that compares a plurality of topics 226 indicated in the query 224. The plurality of topics 226 may include a first topic 228 (e.g., topic A) and a second topic 230 (e.g., topic B), as illustrated in FIG. 2. However, in other embodiments, the plurality of topics 226 may include any number of topics indicated by the user in the query 224.

Each topic (e.g., first topic 228; second topic 230) of the plurality of topics 226 may include one or more features 232 which may form the basis of the comparison. Some examples of features 232 may include, characters, attributes, and events, as shown below in Table 1. In other embodiments, the features 232 may include additional and/or alternative comparison elements not shown in Table 1.

TABLE 1

| CHARACTERS | ATTRIBUTES | EVENT |
|---|---|---|
| Person A | Long Pass | FIFA World Cup |
| Person B | Short Pass | Africa Cup |
| Person C | Penalty Kick | Copa America |
| — | Centripetal Force | — |
| — | Centrifugal Force | — |

In one embodiment, the user may ask questions (e.g., query 224) based on a combination of one or more fields (e.g., features 232) in Table 1. For example, the query 224 from the user may request a video comparing the penalty kicks of Lionel Messi and Cristiano Ronaldo in FIFA World Cups. In this first example, the video comparison program 150 may detect the first topic 228 as including three features 232: Lionel Messi, penalty kick, and FIFA World Cup and the second topic 230 as including three features 232: Cristiano Ronaldo, penalty kick, and FIFA World Cup. In a second example, the query 224 from the user may request a video comparing centripetal force and centrifugal force. In this second example, the video comparison program 150 may detect the first topic 228 as including one feature 232: centripetal force and the second topic 230 as including one feature 232: centrifugal force.

The search module 212 of the video comparison program 150 may detect that the query 224 is a comparison query based on the contents of the query 224. According to one embodiment, the search module 212 may analyze of the text of the query 224 using natural language processing (NLP) to identify an intent to compare the plurality of topics 226 in the query 224. If the query 224 is identified as a comparison query, the search module 212 may search a video repository 234 (e.g., in database 210) to retrieve one or more relevant video content 236 associated with the plurality of topics 226 in the query 224. In one embodiment, the search module 212 may split the query 224 into multiple independent queries corresponding to the plurality of topics 226. As such, in at least one embodiment, the search module 212 may split the query 224 into a first query to search for the first topic 228 and a second query to search for the second topic 230.

According to one embodiment, the search module 212 may identify video content indexed in the video repository 234 which may be associated with the plurality of topics 226. Then, the search module 212 may implement an algorithm to hierarchically rank the video content and output the relevant video content 236. In one embodiment, the relevant video content 236 may include a set of video results that are most related to the plurality of topics 226 in the query 224.

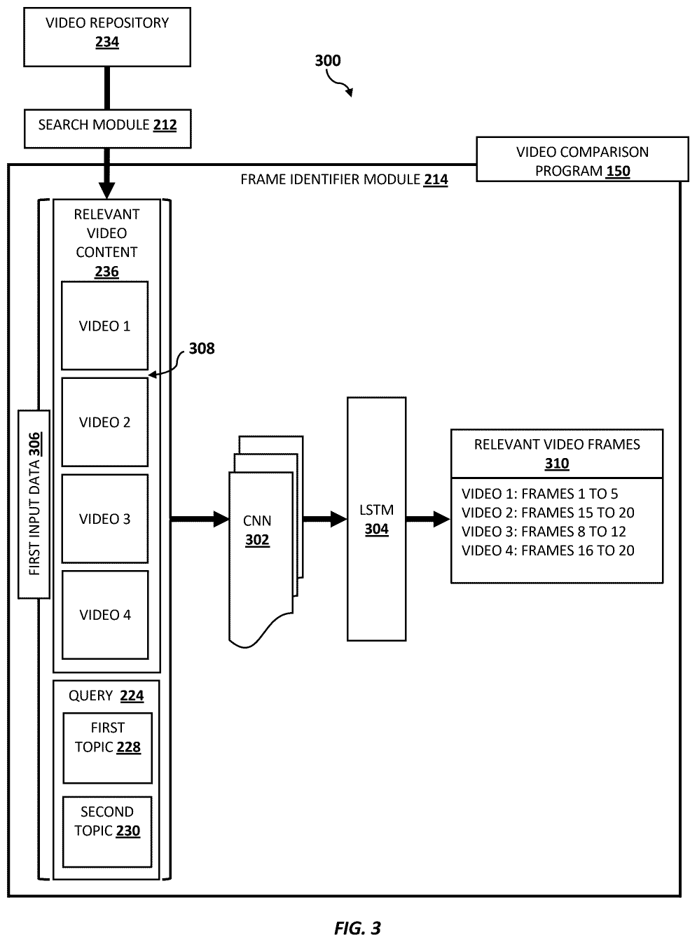

According to one embodiment, once the relevant video content 236 are processed by the frame identifier module 214, frame classifier module 216, summarization module 218, comparison prediction module 220, and video generation module 222—as will further detailed with reference to FIGS. 3-8—the video comparison program 150 may output a video comparison summary 238 to the client device 204 that compares the plurality of topics 226 included in the query 224.

In one embodiment, the video comparison summary 238 may include an intra-frame comparison 240 (intra-frame comparison video) or an inter-frame comparison 242 (inter-frame comparison video) based on a prediction using the comparison prediction module 220 that determines the best video comparison format (e.g., most suitable for visualizing the comparisons) for the video comparing the plurality of topics 226 included in the query 224. In one embodiment, the intra-frame comparison 240 may include a first topic video 244 and a second topic video 246 compared within a same frame (e.g., displaying first topic video 244 and second topic video 246 simultaneously). In one embodiment, the inter-frame comparison 242 may include the first topic video 244 and the second topic video 246 compared sequentially between different frames (e.g., displaying first topic video 244 and second topic video 246 sequentially).

According to another embodiment, the query 224 may be based on an input video 248 provided by the user. In such embodiments, the user may provide the first topic 228 and the input video 248 and request a video (e.g., video comparison summary 238) that compares the first topic 228 indicated in the query 224 to the input video 248.

As a third example under this embodiment, the user may request for a video comparing the penalty kick of Lionel Messi in the FIFA World Cup to the input video 248. As a fourth example under this embodiment, the user may request for a video of Lionel Messi penalty kicks in the FIFA World Cup that is similar to the input video 248 (e.g., the input video 248 may include a video of other penalty kicks by Lionel Messi or penalty kicks by another player). The video comparison program 150 may extract text from the input video 248 and convert the input video 248 into the second topic 230. In this embodiment, the video comparison program 150 may retrieve (e.g., from the video repository 234) relevant video content 236 associated with the first topic 228 and utilize the input video 248 provided by the user as the relevant video content 236 for the second topic 230. As such, the first topic video 244 in the video comparison summary 238 may be based on the relevant video content 236 retrieved for the first topic 228 and the second topic video 246 in the video comparison summary 238 may be based on the input video 248 provided by the user.

Referring now to FIG. 3, a schematic block diagram of a frame identifier process 300 according to at least one embodiment is illustrated. According to one embodiment, the frame identifier process 300 may be implemented by the frame identifier module 214 comprising a CNN 302 and an LSTM network 304. In one embodiment, the frame identifier module 214 may receive first input data 306 including the relevant video content 236 from the search module 212 and the query 224 from the client device 204. The relevant video content 236 may include a plurality of video files 308 (e.g., video 1, video 2, video 3, video 4) associated with the plurality of topics 226 (e.g., first topic 228 and second topic 230) described in the query 224. In one embodiment, each topic (e.g., first topic 228) may include at least one video file in the plurality of video files 308.

The frame identifier module 214 may be enabled by the CNN 302 and LSTM network 304 to recognize objects (e.g., in a single image/frame) and actions/activities (e.g., a sequence of images/frames) in the relevant video content 236 based on the plurality of topics 226 (e.g., first topic 228 and second topic 230) described in the query 224. In one embodiment, the CNN 302 and LSTM network 304 may process the user requested content details in the query 224 (e.g., textual description of the plurality of topics 226 being compared) and the relevant video content 236 to recognize, in one or more relevant video frames 310 of the relevant video content 236, the objects, actions, and activities described in the query 224. In one embodiment, the CNN 302 and LSTM network 304 may extract from each video file of the plurality of video files 308, at least one video frame relevant (e.g., in relevant video frames 310) to the respective topics of the plurality of topics 226.

According to one embodiment, the CNN 302 may include at least three layers: an input layer, one or more hidden layers, and an output layer. The CNN 302 may be implemented to classify objects in the video frames of the plurality of video files 308 and the LSTM network 304 may be implemented to model the long-term contextual information of temporal sequences in the video frames of the plurality of video files 308 to recognize actions and activities. Together, the CNN 302 and LSTM network 304 may output the relevant video frames 310 of the relevant video content 236 that has the user requested content of the plurality of topics 226.

For example, as shown in FIG. 3, the CNN 302 and LSTM network 304 may analyze four video files (e.g., plurality of video files 308: video 1, video 2, video 3, and video 4) as being the relevant video content 236 to query 224 (e.g., first topic 228, second topic 230). Based on the textual descriptions of the first topic 228 and the second topic 230, the CNN 302 and LSTM network 304 may extract four sets of relevant video frames 310: frames 1 to 5 for video 1, frames 15 to 20 for video 2, frames 8 to 12 for video 3, and frames 16 to 20 for video 4.

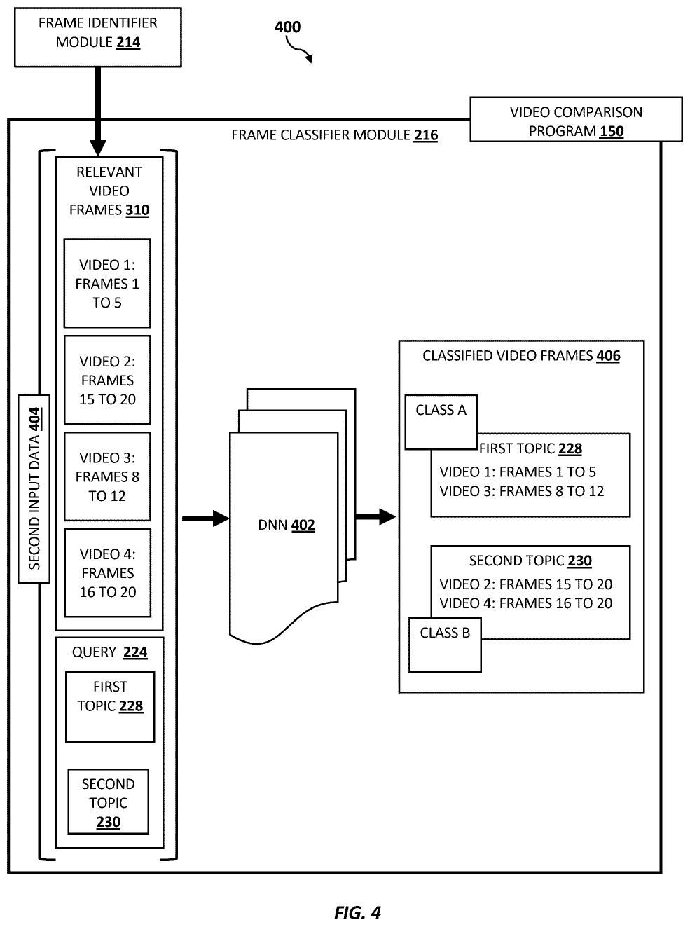

Referring now to FIG. 4, a schematic block diagram of a frame classifier process 400 according to at least one embodiment is illustrated. According to one embodiment, the frame classifier process 400 may be implemented by the frame classifier module 216 comprising a DNN 402. The DNN 402 may include an input layer, multiple hidden layers, and an output layer. The output layer may include a softmax layer configured to identify respective classifications of the input relevant video frames 310.

In one embodiment, the frame classifier module 216 may receive second input data 404 including the relevant video frames 310 from the frame identifier module 214 and the query 224 from the client device 204. In one embodiment, the DNN 402 may map the relevant video frames 310 of the relevant video content 236 to a respective topic of the plurality of topics 226 (e.g., first topic 228, second topic 2230) in the query 224. In one embodiment, each topic of the plurality of topics 226 may be considered a classification (e.g., class A: first topic 228; class B: second topic 230). The DNN 402 may output one or more classified video frames 406 including the classifications of the relevant video frames 310 to one of the plurality of topics 226 (e.g., first topic 228, second topic 2230) in the query 224 based on the similarities and differences in the relevant video frames 310.

For example, as shown in FIG. 4, the DNN 402 may output one or more classified video frames 406 including two classes: class A for the first topic 228 and class B for the second topic 230. In this example, the DNN 402 may map frames 1 to 5 of video 1 and frames 8 to 12 of video 3 as being associated with the first topic 228 (class A) and frames 15 to 20 of video 2 and frames 16 to 20 of video 4 as being associated with the second topic 230 (class B). In the example where the first topic 228 includes: Lionel Messi's penalty kicks in the FIFA World Cup and the second topic 230 includes: Cristiano Ronaldo's penalty kicks in the FIFA World Cup, the DNN 402 may determine that frames 1 to 5 of video 1 and frames 8 to 12 of video 3 depicts the first topic 228 (class A) and may further determine that frames 15 to 20 of video 2 and frames 16 to 20 of video 4 depicts the second topic 230 (class B).

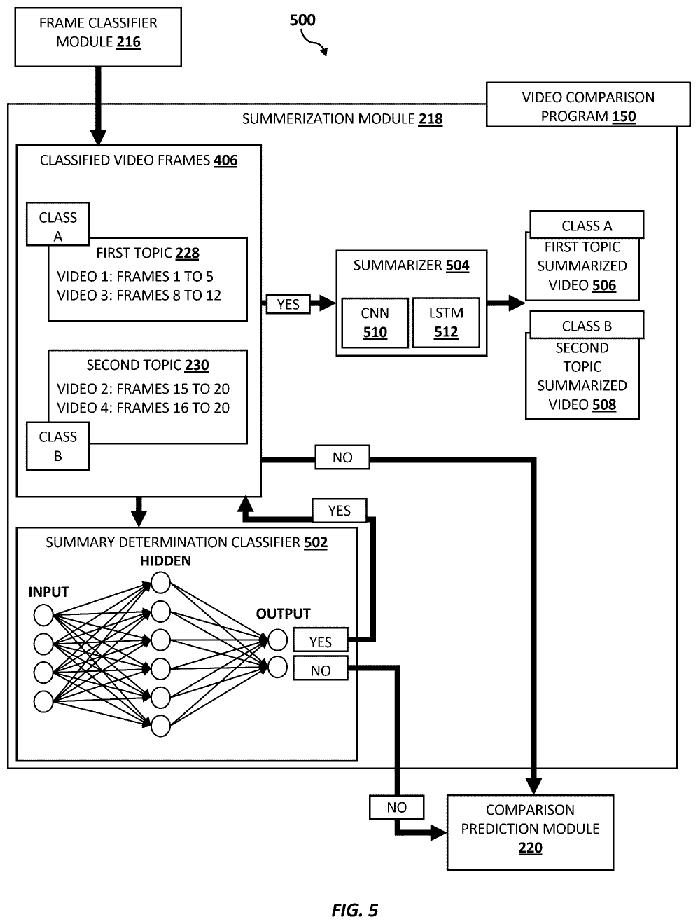

Referring now to FIG. 5, a schematic block diagram of a summarization process 500 according to at least one embodiment is illustrated. The summarization process 500 may be implemented by the summarization module comprising a summary determination classifier 502 and a summarizer 504. In at least one embodiment, the summarization module 218 may skip the summary determination classifier 502 and implement the summarizer 504 on all the classified video frames 406 received from the frame classifier module 216. In another embodiment, the summary determination classifier 502 (e.g., CNN classifier) may receive the classified video frames 406 from the frame classifier module 216 and evaluate the relevant video frames 310 under each class (e.g., first topic 228 (class A); second topic 230 (class B)) to determine if a shorter version of the relevant video frames 310 under each class may be generated without diminishing comprehension of the relevant video frames 310. In one embodiment, the summary determination classifier 502 may classify the classified video frames 406 as a candidate for summarization (“yes” branch) if a summarized version may be used to convey the relevant information from the relevant video frames 310 while increasing storage utilization. In another embodiment, the summary determination classifier 502 may classify the classified video frames 406 as a candidate for summarization (“yes” branch) if a summarized version may be used to combine the relevant information from multiple videos while removing redundant information, which may also increase storage utilization. In one embodiment, the summary determination classifier 502 may classify the classified video frames 406 as a non-candidate for summarization (“no” branch) if a summarized version may not be used to convey the relevant information from the relevant video frames 310 (e.g., summary would diminish comprehension of the relevant video frames 310). In another embodiment, one class of the classified video frames 406 may be classified as a candidate for summarization while another class of the classified video frames 406 may be classified as a non-candidate for summarization. For example, class A may be classified as a candidate for summarization while class B may be classified as a non-candidate for summarization.

If the classified video frames 406 are not candidates for summarization (“no” branch), the video comparison program 150 may transmit the classified video frames 406 to the comparison prediction module 220. However, if any of the classified video frames 406 may be a candidate for summarization (“yes” branch), the summarization module 218 may transmit the classified video frames 406 to the summarizer 504 to generate a summarized video for the given topic (e.g., first topic summarized video 506, second topic summarized video 508). In one embodiment, the first topic summarized video 506 may be referred to as a summarized video for class A and the second topic summarized video 508 may be referred to as a summarized video for class B.

In one embodiment, the summarizer 504 may include a CNN 510 and an LSTM network 512 which may generate efficient video summaries based on the query 224 (e.g., summarized video conveys relevant information from the text of the query 224 and discards other information). In other embodiments, the summarizer 504 may also be implemented using additional or alternative machine learning models.

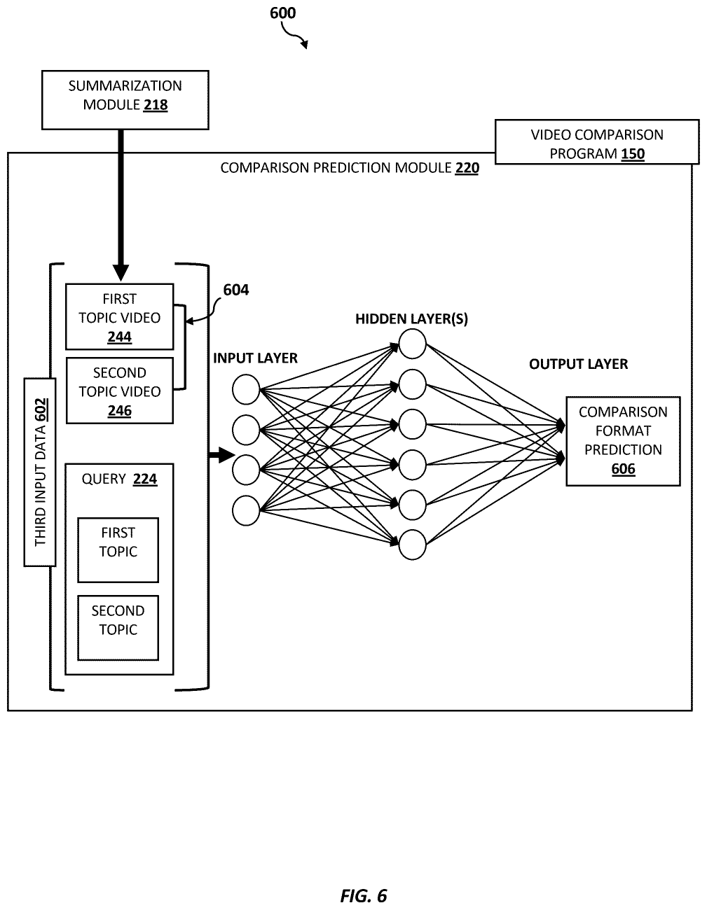

Referring now to FIG. 6, a schematic block diagram of a comparison prediction process 600 according to at least one embodiment is illustrated. The comparison prediction process 600 may be implemented by the comparison prediction module 220. In one embodiment, the comparison prediction module 220 may receive third input data 602 including a plurality of topic videos 604 (e.g., first topic video 244, second topic video 246) from the summarization module 218 and the query 224 from the client device 204. In one embodiment, the first topic video 244 may include the first topic summarized video 506 and the second topic video 246 may include the second topic summarized video 508 from the summarization module 218. As described with reference to FIG. 5, in at least one embodiment, the summarization module 218 may determine that the classified video frames 406 do not need to be summarized and may transmit the classified video frames 406 to the comparison prediction module 220. In such embodiments, the plurality of topic videos 604 in the third input data 602 may include the classified video frames 406 (e.g., without being summarized) for the topic (e.g., class) determined to not need summarization by the summary determination classifier 502.

In one embodiment, the comparison prediction module 220 may include a DNN (e.g., input layer, hidden layer(s), and output layer) that is trained to output a comparison format prediction 606. The comparison format prediction 606 may include a confidence score indicating whether to generate the video comparison summary 238 as the intra-frame comparison 240 or the inter-frame comparison 242, as shown in FIG. 2. In the intra-frame comparison 240, the content/classified videos may fit into the same frame (e.g., first topic video 244 and second topic video 246 displayed simultaneously and adjacently in the same frame as shown in FIG. 2). In the inter-frame comparison 242, the content/classified videos may be displayed in sequence one after the other (e.g., first display first topic video 244 then display second topic video 246 as shown in FIG. 2). It is contemplated that the comparison prediction module 220 may choose between the intra-frame comparison 240 or the inter-frame comparison 242 based on various factors such as, for example, the optimal video dimensions to convey the requested comparison in the query 224, the number of topics being compared (e.g., number of videos being compared), screen size of the client device 204, category of the topic being compared (e.g., sports videos; educational videos). In at least one embodiment, the comparison prediction module 220 may generate the comparison format prediction 606 (e.g., intra-frame comparison 240 or inter-frame comparison 242) based on additional and/or alternative factors not detailed above.

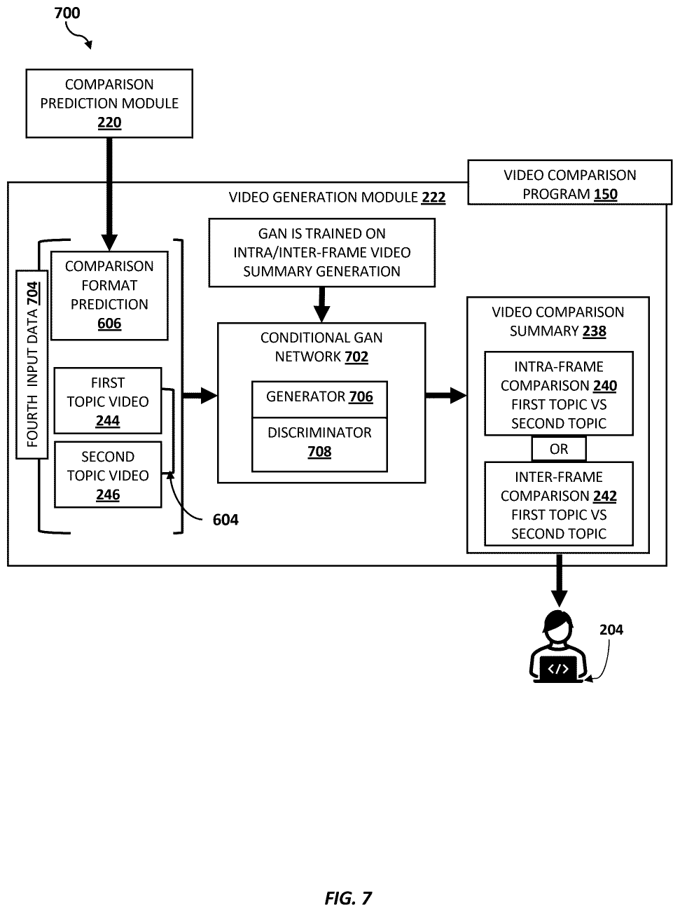

Referring now to FIG. 7, a schematic block diagram of a video generation process 700 according to at least one embodiment is illustrated. The video generation process 700 may be implemented by the video generation module 222 comprising a conditional GAN network 702 that is trained on intra/inter-frame video summary generation. In one embodiment, the conditional GAN network 702 may receive a fourth input data 704 including the comparison format prediction 606 from the comparison prediction module 220 and the plurality of topic videos 604 (e.g., first topic video 244, second topic video 246) from the summarization module 218.

In one embodiment, the first topic video 244 may include the first topic summarized video 506 and the second topic video 246 may include the second topic summarized video 508 from the summarization module 218. However, in at least one embodiment, the summarization module 218 may determine that the classified video frames 406 do not need to be summarized. In such embodiments, the plurality of topic videos 604 in the fourth input data 704 may include the classified video frames 406 (e.g., without being summarized) for the topic (e.g., class) determined to not need summarization by the summary determination classifier 502.

In one embodiment, the conditional GAN network 702 may include a generator 706 and a discriminator 708 which may enable the conditional GAN network 702 to generate the video comparison summary 238 as a realistic video as determined by the discriminator 708. As noted above, the video comparison summary 238 may be generated as the intra-frame comparison 240 or the inter-frame comparison 242 based on the comparison format prediction 606. Thereafter, the video comparison program 150 may transmit the video comparison summary 238 on the client device 204 in response to the query 224. It is contemplated that the video comparison program 150 may provide the video comparison summary 238 to the client device 204 in real-time in response to receiving the query 224 from the client device 204.

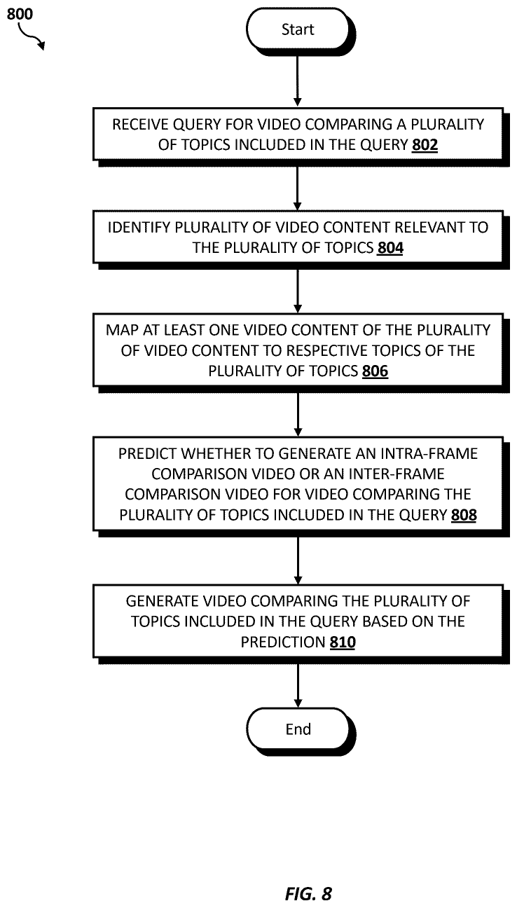

Referring now to FIG. 8, an operational flowchart illustrating an exemplary process 800 used by the video comparison program 150 according to at least one embodiment is depicted. According to one embodiment, FIG. 8 provides a description of process 800 with reference to FIGS. 2-7.

At 802, a query is received for a video comparing a plurality of topics included in the query. According to one embodiment, the video comparing the plurality of topics may include a video comparison summary that summarizes one or more similarities/differences between the plurality of topics included in the query, as described previously with reference to FIGS. 2-7. In one embodiment, the query may be based on text received from the user. However, in at least one embodiment, the query may be based on at least one input video provided by the user. In such embodiments, the video comparison program 150 may receive the at least one input video in the query. Then, the video comparison program 150 may transform the at least one input video into at least one topic of the plurality of topics of the query. Next, the video comparison program 150 may integrate the at least one input video in the video comparing the plurality of topics (e.g., video comparison summary), as described previously with reference to FIG. 2.

Then, at 804, a plurality of video content relevant to the plurality of topics are identified. According to one embodiment, the video comparison program 150 may access a video repository and retrieve a plurality of video files associated with the plurality of topics in the query, as described previously with reference to FIG. 3. Then, the video comparison program 150 may extract from each video file of the plurality of video files, at least one video frame relevant to the respective topics of the plurality of topics, as described previously with reference to FIG. 3. Thus, in at least one embodiment, the plurality of video content relevant to the plurality of topics may include the at least one video frame relevant to the respective topics of the plurality of topics.

Next, at 806 at least one video content of the plurality of video content is mapped to respective topics of the plurality of topics. According to one embodiment, mapping the at least one video content to the respective topics of the plurality of topics may include the video comparison program 150 classifying the at least one video frame (e.g., the relevant video frames of the relevant video content) from each video file of the plurality of video files into the respective topics of the plurality of topics. In one embodiment, the video comparison program 150 may implement a DNN to perform the classification based on the similarities and differences between the at least one video frame from each video file of the plurality of video files, as described previously with reference to FIG. 4.

Next, 808, a prediction is made as to whether to generate an intra-frame comparison video or an inter-frame comparison video for the video comparing the plurality of topics included in the query. According to one embodiment, the video comparison program 150 may implement a DNN that is trained to output a comparison format prediction indicating whether to generate the video comparison summary as an intra-frame comparison video (e.g., single frame simultaneously displaying the plurality of video content for comparison) or an inter-frame comparison video (e.g., sequence of frames consecutively displaying the plurality of video content for comparison), as described previously with reference to FIG. 6. In one embodiment, the DNN may predict the comparison format based on the plurality of topic videos and the query indicating the plurality of topics for comparison. In one embodiment, the plurality of topic videos may include a video summary of the relevant video content for at least one topic of the plurality of topics. In another embodiment, the plurality of topic videos may include no video summaries or at least one relevant video content that is not summarized. According to one embodiment, the video comparison program 150 may determine whether to generate a video summary for any topic of the plurality of topics based on the at least one video content mapped to the respective topics of the plurality of topics, as described previously with reference to FIG. 5.

Thereafter, at 810, video is generated comparing the plurality of topics included in the query based on the prediction. According to one embodiment, the video comparison program 150 may implement a GAN model (e.g., trained on intra/inter-frame video summary generation) to generate the video comparison summary. In one embodiment, the video comparison summary may display the plurality of video content mapped to the respective topics of the plurality of topics for comparison in the format predicted by the video comparison program 150 (e.g., intra-frame comparison video or inter-frame comparison video). In one embodiment, each video in the video comparison summary may include a video summary of the at least one video content mapped to the respective topics of the plurality of topics (e.g., summary of the relevant video frames of the relevant video content). In another embodiment, the video comparison summary may include at least one relevant video content that is not summarized. Once the video comparison summary is generated, the video comparison program 150 may transmit the video comparison summary to the client device in response to the query from the user, as described previously with reference to FIG. 7. It is contemplated that the video comparison program 150 may provide the video comparison summary in real-time (e.g., dynamically generated) in response to receiving the query from the client device.

It may be appreciated that FIGS. 2 to 8 provide only an illustration of one embodiment and do not imply any limitations with regard to how different embodiments may be implemented. Many modifications to the depicted embodiment(s) may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving a query for a video comparing a plurality of topics included in the query;
identifying a plurality of video content relevant to the plurality of topics;
mapping at least one video content of the plurality of video content to respective topics of the plurality of topics;
predicting whether to generate an intra-frame comparison video or an inter-frame comparison video for the video comparing the plurality of topics included in the query; and
generating the video comparing the plurality of topics included in the query based on the prediction.

2. The computer-implemented method of claim 1, wherein the identifying the plurality of video content relevant to the plurality of topics further comprises:
retrieving, from a video repository, a plurality of video files associated with the plurality of topics; and
extracting, from each video file of the plurality of video files, at least one video frame relevant to the respective topics of the plurality of topics.

3. The computer-implemented method of claim 2, wherein the mapping the at least one video content of the plurality of video content to the respective topics of the plurality of topics further comprises:
classifying the at least one video frame from each video file of the plurality of video files into the respective topics of the plurality of topics.

4. The computer-implemented method of claim 1, further comprising:
determining whether to generate a video summary for any topic of the plurality of topics based on the at least one video content mapped to the respective topics of the plurality of topics; and
in response to determining to generate the video summary for at least one topic of the plurality of topics, integrating the video summary generated for the at least one topic of the plurality of topics into the video comparing the plurality of topics.

5. The computer-implemented method of claim 1, wherein the intra-frame comparison video includes a single frame simultaneously displaying the plurality of video content mapped to the respective topics of the plurality of topics for comparison.

6. The computer-implemented method of claim 1, wherein the inter-frame comparison video includes a sequence of frames consecutively displaying the plurality of video content mapped to the respective topics of the plurality of topics for comparison.

7. The computer-implemented method of claim 1, wherein the receiving the query for the video comparing the plurality of topics included in the query further comprises:
receiving at least one input video in the query;
transforming the at least one input video into at least one topic of the plurality of topics; and
integrating the at least one input video in the video comparing the plurality of topics.

8. A computer system for dynamically generated video comparison summary, comprising:
one or more processors, one or more computer-readable memories, one or more computer-readable tangible storage media, and program instructions stored on at least one of the one or more computer-readable tangible storage media for execution by at least one of the one or more processors via at least one of the one or more computer-readable memories, wherein the computer system is capable of performing a method comprising:
receiving a query for a video comparing a plurality of topics included in the query;
identifying a plurality of video content relevant to the plurality of topics;
mapping at least one video content of the plurality of video content to respective topics of the plurality of topics;
predicting whether to generate an intra-frame comparison video or an inter-frame comparison video for the video comparing the plurality of topics included in the query; and
generating the video comparing the plurality of topics included in the query based on the prediction.

9. The computer system of claim 8, wherein the identifying the plurality of video content relevant to the plurality of topics further comprises:
retrieving, from a video repository, a plurality of video files associated with the plurality of topics; and
extracting, from each video file of the plurality of video files, at least one video frame relevant to the respective topics of the plurality of topics.

10. The computer system of claim 9, wherein the mapping the at least one video content of the plurality of video content to the respective topics of the plurality of topics further comprises:
classifying the at least one video frame from each video file of the plurality of video files into the respective topics of the plurality of topics.

11. The computer system of claim 8, further comprising:
determining whether to generate a video summary for any topic of the plurality of topics based on the at least one video content mapped to the respective topics of the plurality of topics; and
in response to determining to generate the video summary for at least one topic of the plurality of topics, integrating the video summary generated for the at least one topic of the plurality of topics into the video comparing the plurality of topics.

12. The computer system of claim 8, wherein the intra-frame comparison video includes a single frame simultaneously displaying the plurality of video content mapped to the respective topics of the plurality of topics for comparison.

13. The computer system of claim 8, wherein the inter-frame comparison video includes a sequence of frames consecutively displaying the plurality of video content mapped to the respective topics of the plurality of topics for comparison.

14. The computer system of claim 8, wherein the receiving the query for the video comparing the plurality of topics included in the query further comprises:
receiving at least one input video in the query;
transforming the at least one input video into at least one topic of the plurality of topics; and
integrating the at least one input video in the video comparing the plurality of topics.

15. A computer program product for dynamically generated video comparison summary, comprising:
one or more computer-readable storage media and program instructions collectively stored on the one or more computer-readable storage media, the program instructions executable by a processor to cause the processor to perform a method comprising:
receiving a query for a video comparing a plurality of topics included in the query;
identifying a plurality of video content relevant to the plurality of topics;
mapping at least one video content of the plurality of video content to respective topics of the plurality of topics;
predicting whether to generate an intra-frame comparison video or an inter-frame comparison video for the video comparing the plurality of topics included in the query; and
generating the video comparing the plurality of topics included in the query based on the prediction.

16. The computer program product of claim 15, wherein the identifying the plurality of video content relevant to the plurality of topics further comprises:
retrieving, from a video repository, a plurality of video files associated with the plurality of topics; and
extracting, from each video file of the plurality of video files, at least one video frame relevant to the respective topics of the plurality of topics.

17. The computer program product of claim 16, wherein the mapping the at least one video content of the plurality of video content to the respective topics of the plurality of topics further comprises:
classifying the at least one video frame from each video file of the plurality of video files into the respective topics of the plurality of topics.

18. The computer program product of claim 15, further comprising:
determining whether to generate a video summary for any topic of the plurality of topics based on the at least one video content mapped to the respective topics of the plurality of topics; and
in response to determining to generate the video summary for at least one topic of the plurality of topics, integrating the video summary generated for the at least one topic of the plurality of topics into the video comparing the plurality of topics.

19. The computer program product of claim 15, wherein the intra-frame comparison video includes a single frame simultaneously displaying the plurality of video content mapped to the respective topics of the plurality of topics for comparison.

20. The computer program product of claim 15, wherein the inter-frame comparison video includes a sequence of frames consecutively displaying the plurality of video content mapped to the respective topics of the plurality of topics for comparison.
